(19) United States
(12) Patent Application Publication
(10) Pub. No.: US 2024/0073000 A1
(43) Pub. Date: Feb. 29, 2024

(54) PROTECTIONS AGAINST BROWSER-IN-BROWSER ATTACKS

(71) Applicant: Red Hat, Inc., Raleigh, NC (US)

(72) Inventor: Michael Tsirkin, Yokneam Illit (IL)

(21) Appl. No.: 17/898,689

(22) Filed: Aug. 30, 2022

(51) Int. Cl. H04L 9/08

(52) U.S. Cl. CPC H04L 9/0825; H04L 9/0891

(57) ABSTRACT

Protections against browser-in-browser attacks are provided by in response to opening a first browser window and a second browser window, retrieving security key information stored by a browser application that are held outside of a document object model accessible by documents through the browser application; displaying a first instance of the security key information in the first browser window; and displaying, contemporaneously with display of the first instance of the security key information, a second instance of the security key information in the second browser window.

### BACKGROUND

Browser-in-browser attacks, also referred to browser-in-the-browser (BitB) attacks, are spoof-based attacks, which seek to extract information from users by supplying a facsimile of a legitimate browser window to extract information from trusting users (e.g., a phishing attack). For example, a malicious party may exploit a third-party single sign-on feature embedded in a website via a fabricated browser window, rather than a pop-up window or new browser window within the original window. This fabricated browser window may be designed to mimic the look and feel of a legitimate sign-on window, and may send the user to a malicious website to collect more information from the victim in addition to any log-in credential extracted via the fabricated browser window. These design elements may aid in putting the user at ease to then extract sensitive information from the user, and can include further design element, such as spoofed Uniform Resource Locators (URLs) to make distinguishing real log-in prompts from fake log-in prompts difficult.

### SUMMARY

The present disclosure provides new and innovative protections for against browser-in-browser attacks that result in improvements to in the security of computing devices, among other benefits. In one example, a method is provided that comprises in response to opening a first browser window and a second browser window, retrieving security key information stored by a browser application that are held outside of a document object model accessible by documents through the browser application; displaying a first instance of the security key information in the first browser window; and displaying, contemporaneously with display of the first instance of the security key information, a second instance of the security key information in the second browser window.

In one example, a system is provided that comprises a processor; and a memory, including instructions that when executed by the processor perform operations including: in response to opening a first browser window and a second browser window, retrieving security key information stored by a browser application that are held outside of a document object model accessible by documents through the browser application; displaying a first instance of the security key information in the first browser window; and displaying, contemporaneously with display of the first instance of the security key information, a second instance of the security key information in the second browser window.

In one example, a memory device is provided that includes instructions that when executed by a processor perform operations including: in response to opening a first browser window and a second browser window, retrieving security key information stored by a browser application that are held outside of a document object model accessible by documents through the browser application; displaying a first instance of the security key information in the first browser window; and displaying, contemporaneously with display of the first instance of the security key information, a second instance of the security key information in the second browser window.

Additional features and advantages of the disclosed methods, devices, and/or systems are described in, and will be apparent from, the following Detailed Description and the Figures.

### BRIEF DESCRIPTION OF THE FIGURES

FIG. 1 is a flowchart of a method for providing protections against browser-in-browser attacks, according to examples of the present disclosure.

FIGS. 2A and 2B illustrate time series of assurances that a browser-in-browser attack is not ongoing, according to examples of the present disclosure.

FIGS. 3A-3C illustrate time series for detection of a browser-in-browser attack, according to examples of the present disclosure.

FIG. 4 illustrates physical components of an example computing device according to examples of the present disclosure.

### DETAILED DESCRIPTION

Browser applications, also referred to as web browsers or Internet browsers, are software applications that allow users to view websites including various content from webservers that may be defined in a markup language, referenced or called by the markup language, or references or called by another object served with the website. Various websites restrict access to content behind user credentials (e.g., usernames and passwords) that are specific to the website in question, or that are verified by a third party. Third-party sign-on allows a user to authenticate with a first website without setting specific user credentials with that website, and instead requests that a third-party, such as a social media provider, verify the user's identity to provide access to the restricted content (e.g., account management tools, user-specific articles or videos, web-based email, online services, etc.). Website operators are increasingly offering user the ability to log-in using third-party sign-in as an option for users to access content, as the web site operator does not have to maintain (and secure) a list of user credentials, and instead passes these responsibilities on to the third-party authorizer, often referred to as an Open Authorization (OAuth) provider, among other benefits. When offering user the ability to login via an OAuth provider, the initial website can direct the user to a login page or provide a pop-up window (e.g., a new browser session in a new tab or window) to allow the user to select and provide credential to the OAuth provider, which on acceptance of these credentials, authorizes the initial website to direct the user to the restricted content.

However, the look and feel of these pop-up windows can be mimicked by malicious parties as part of a phishing attack to gain login and other information from the user. The malicious party provides a fake pop-up window, often as a frame in the existing browser window rather than a separate window, that mimics what a separate window would look like, and may include falsified Uniform Resource Locator (URL) information so that the user mistakes the fake pop-up window as a legitimate authorization session with a legitimate OAuth provider. The malicious party may harvest the supplied user credentials, and then direct the user to further malicious sites to extract further information from the user or deliver malicious content to the user.

The present disclosure therefore provides protections against browser-in-browser attacks by outputting a security key in actual windows (and tabs thereof) of the browser application to allow users to identify whether a potential window is a fake window or a real window, and therefore whether the contents of that potential window should be seen as spoofed or authentic. These safety key information are included in the browser application (either within the core code of the application or as an add-in to the browser application), but are held outside of the Document Object Model (DOM) of the browser so that applications, documents displayed by the browser (e.g., webpages and associated scripts), and remote services cannot access the security information. The DOM is a programming interface for documents (e.g., webpages and associated scripts) displayed by the browser application, and allows for the document or display window to be modified via various scripting languages, such as JavaScript. For example, by referencing the DOM of the browser application, a website may display a pop-up window in a certain location, at a certain size, or a certain display theme based on the corresponding location, size, and display theme of a parent window. By holding the security key information outside of the DOM of the browser application, however, the browser application itself can access the security information to affect display of the windows, tabs, and associated controls (e.g., a command ribbon) provided by the browser application, but no scripts run by external parties can access that information to affect the display of the documents (e.g., web pages and frames thereof) within the browser windows. Accordingly, legitimate windows may incorporate the security information, while fake windows, as document contents configured to mimic windows, cannot access the security information to mimic the look and feel of the legitimate windows.

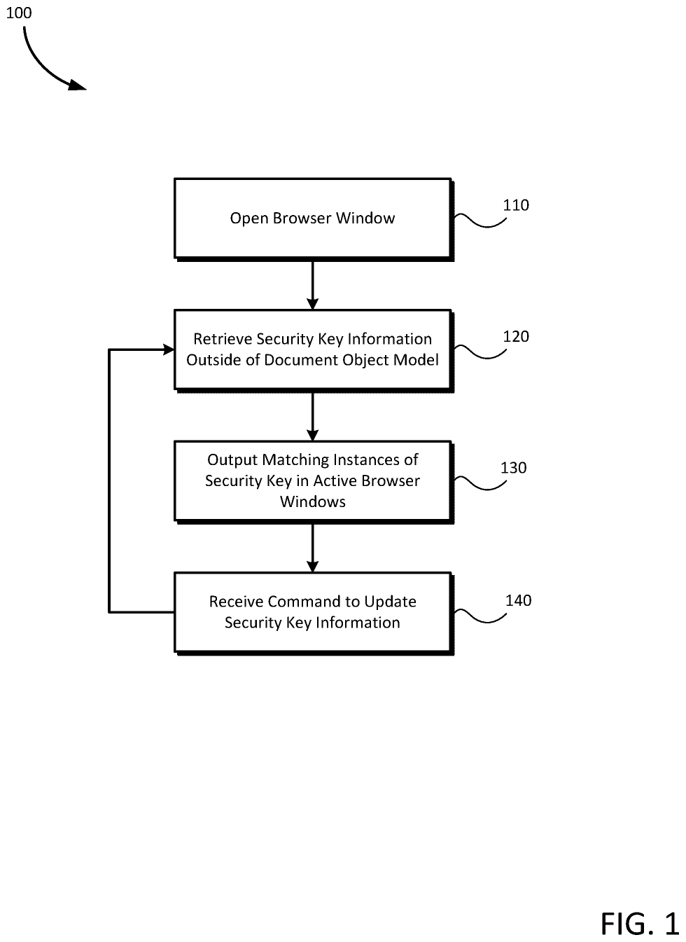

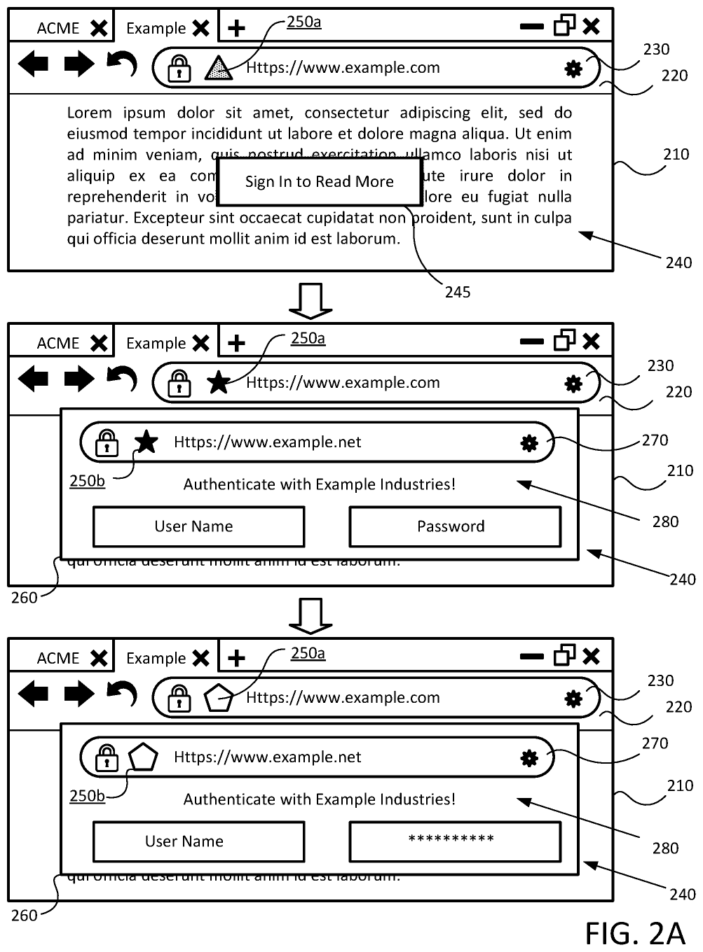

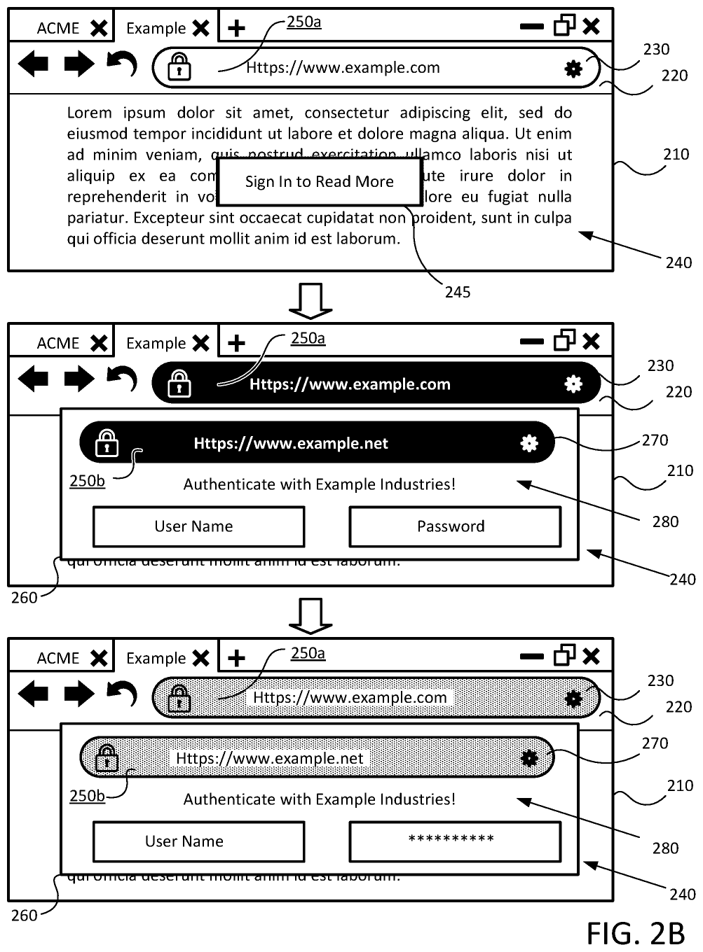

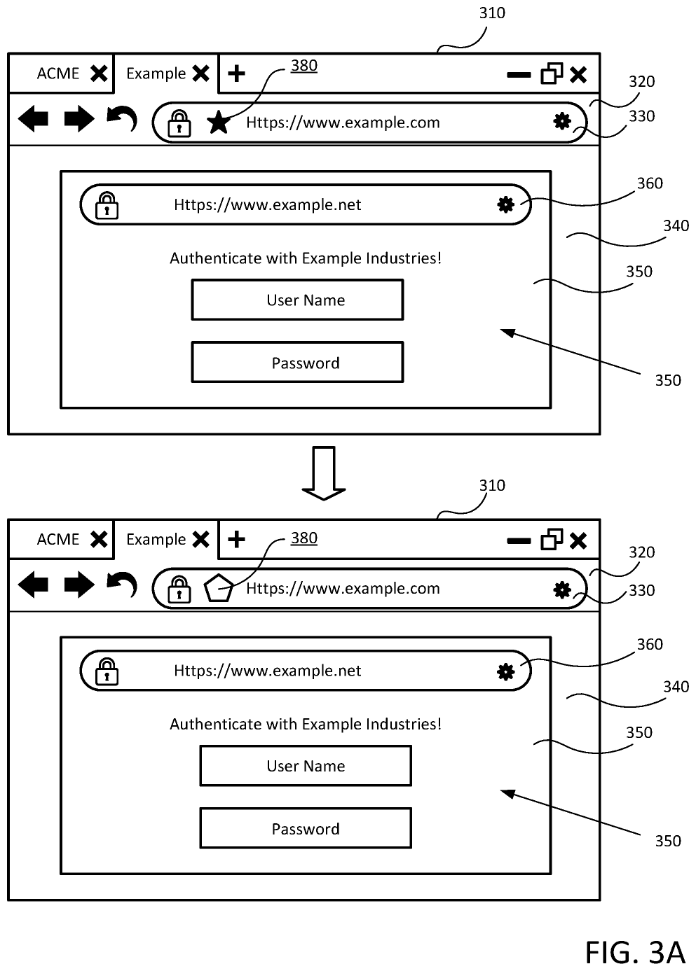

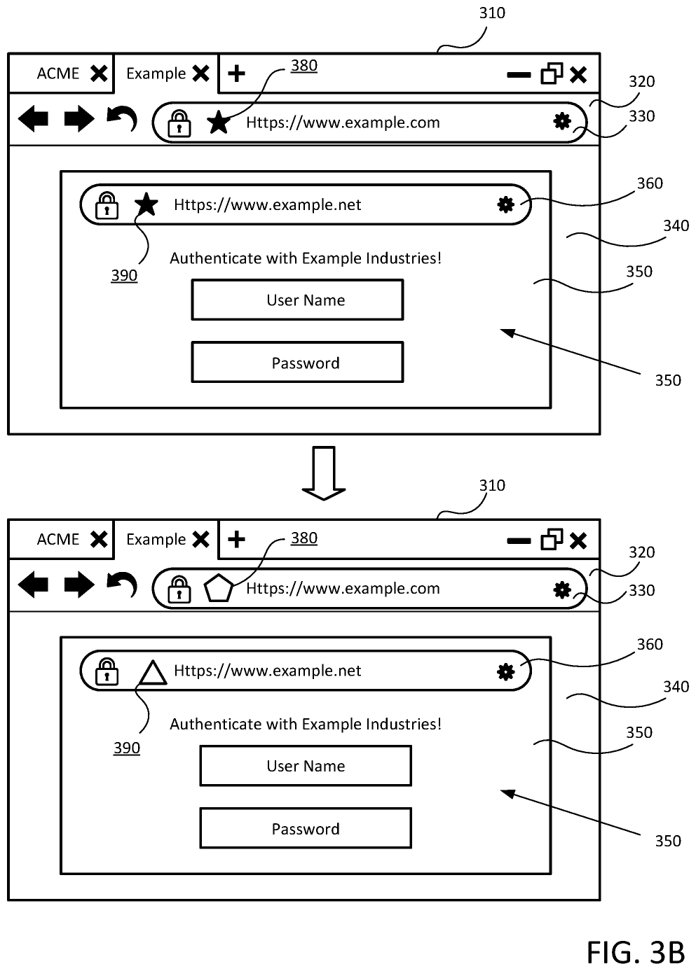

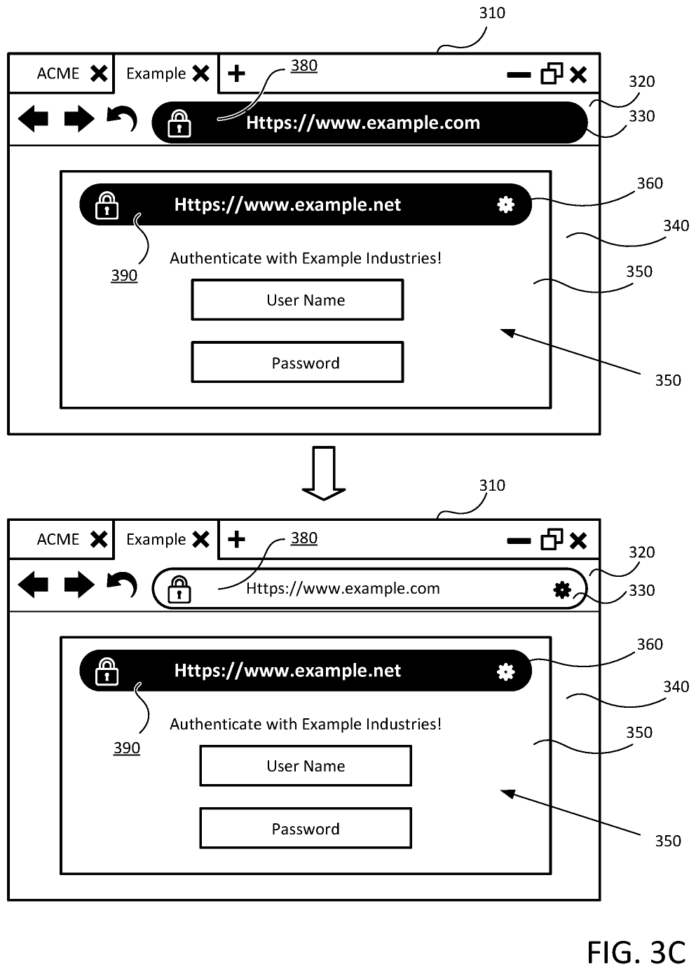

FIG. 1 is a flowchart of a method 100 for providing protections against browser-in-browser attacks, according to examples of the present disclosure. Method 100 begins at block 110 where the user or an application on a computing device opens a browser window. The browser window refers to a window of the browser application used to display documents, such as webpages, and includes the controls for manipulating the browser and which documents are displayed. Depending on the operating system, browser application, and user preferences, the number, location, and functionalities of the controls may vary. For example, a browser window identified as a pop-up window may omit or hide various controls compared to a main window. Several examples of browser windows are illustrated in FIGS. 2A, 2B, and 3A-3C.

At block 120, the browser application retrieves the security key information from outside of the browser DOM. In various embodiments, the security key information can include information that specify various shapes, images, colors, and combinations thereof, and where the security key is to be displayed in the main browser. In various embodiments, the security key information includes, for example as an accessibility option, a tone or other audio signal as an audio instance. These security key information are stored outside of the browser DOM so that documents (and scripts provided by add-ins or external services) displayed via the browser application cannot reference the security key information to affect display of documents in the browser windows provided by the browser application.

At block 130, the browser application outputs instances of the security key in each active browser window provided by the browser application. For example, n visual instances of an image, color, pattern, shape, or the like, are displayed in the n browser windows provided by the browser application. In various embodiments, visual security key information are displayed in the address bars of each active browser window (e.g., in addition to a URL) or other portion of the browser window that is consistently displayed or that the display thereof cannot be prevented by a document or script accessing the DOM for the browser application.

In embodiments where a user has selected the browser to use audio in addition to or instead of the visual security key information, the matching instances of the security key information can include constructively interfering instances of an audio tone (e.g., increasing in volume based on the number of active windows), the security key information can include a number of pulses to play back a tone that is equal to the number of active browser windows, or a recorded or computer generated voice identifying the number of browser windows open (or other identifying information for the active browser windows).

In various embodiments, different browser applications may specify different or equivalent security key information. For example, browser windows provided by a first browser application may reference first security key information that specifies various colors to apply to an address bar in those browser windows, while browser windows provided by a second browser application (different from the first browser application) may reference second security key information (different from the first security key information) to apply in their respective address bars. Accordingly, the browser windows provided by a given browser application concurrently display matching instances of the security keys, browser windows provided by different browser applications may display non-matching instances of the security keys due to the security keys being based on different security key information.

At block 140, the browser application receives a command update the security key information. For example, when the browser application receives a command to open a new browser window, the browser application interprets the command to open the new browser window as a command to also update the security information output by the active browser windows. In various embodiments, the browser application may also or alternatively update the security key information in response to any one of: a timer expiring (which may be set to a predefined or a random value within a range in response to receiving the last update command), data entry in an active browser window (e.g., a user typing or inserting a username or password, address information, etc.), the browser application losing or regaining focus, a browser window being minimized/maximized/re-sized, a browser window being repositioned in a display area, a browser window closing (if any browser windows remain open thereafter), or the like.

After opening a new browser window, or receiving another command to update the security information, method 100 returns to block 120, where the browser application retrieves updated security information, which can include changes to the visual image, color, pattern, shape, or audio tone or audio to output that replace the output of the earlier-output instances of the security key information. Accordingly, the active browser windows output (per a later iteration of block 130) instances of the updated security key information that match one another to cycle the output of the security information to confound a malicious party from guessing a security key to mimic what the browser windows output.

FIGS. 2A and 2B illustrate a time series of assurances that a browser-in-browser attack is not ongoing, according to examples of the present disclosure. As illustrated in FIGS. 2A and 2B, a first browser window 210 is displayed with a control ribbon 220 including various controls and an address bar 230 displaying the URL of the currently displayed contents 240 of a webpage.

At a first time, the first browser window 210 includes a first instance 250a of the security key information in the address bar 230, illustrated as a gray triangle in FIG. 2A and as a black-text on white-background color scheme in FIG. 2B. The first contents 240 of the webpage are displayed in the first browser window 210, and include a control 245 that, when actuated, generates a second browser window 260 (e.g., for a user to log in to read more of the content 240 than an initial sample).

At a second time (after the first time), the browser application displays a second browser window 260 (e.g., as a pop-up window in response to a user selecting the control 245 in the displayed content 240) including second content 280. In various embodiments, pop-up windows, as a convenience for user, are displayed at or near where a control 245 responsible for the generation of the pop-up window was output on a display device, which may result in some or all of the content 240 from the first browser window 210 being obscured. The second browser window 260 may include the same or a different set of controls than the first browser window 210 and, as illustrated, may omit the control ribbon 220 in some embodiments. However, as a security precaution, the second browser window 260 includes a second address bar 270 including the URL for the webpage for which the second content 280 is displayed. As illustrated, the first address bar 230 and the second address bar 270 display different addresses (e.g., URLs), which is to be expected when a first webpage offers third-party sign-on, where one address would match that of an OAuth provider.

At the second time, in response to an update command based on displaying the new second browser window 260 or a length of time between the first time and the second time exceeding a timer threshold, the browser application updates the security key information to display the first instance 250a and the second instance 250b contemporaneously with one another so that both display a black star in FIG. 2A and a white-text on black-background color scheme in FIG. 2B. By displaying the second instance 250b of the security key information in the second browser window 260 contemporaneously with display of the first instance 250a of the security key information in the first browser window 210, the browser application provides evidence to the user that both browser windows 210/260 are legitimate, and one is not simulating display of the other in a frame, as is discussed in relation to FIGS. 3A-3C.

At a third time (after the second time), the browser application continues to display the second browser window 260 including second content 280, which the user may interact with. For example, in FIGS. 2A and 2B, the user has entered information into a control box in the second browser window 260 at the third time. In various embodiments, the data entry action of typing, pasting in, or selecting via a password manager application a user name or password is interpreted by the browser application as a triggering event to update the instances 250 of the security information so that the replacement of the earlier security information is timed to when the user is focusing on the application and will notice the change in output of the security key information.

In various embodiments, the browser application continues to update the output of the security key information (e.g., based on user interaction with the windows, timer thresholds, etc.) to provide further alerts or assurances to the user whether the windows are legitimate. As illustrated in FIGS. 2A and 2B, the newly updated security information replaces the previously updated security information so that the address bar 230 and address bar 270 include a white pentagon (rather than a black star or gray triangle) in FIG. 2A while in FIG. 2B the address bar 230 and address bar 270 include a black-text on gray-background color scheme (rather than a white-text on black-background or black-text on white-background color scheme). As will be appreciated, various color schemes, shapes, patterns, and orders of display may be deployed to reduce the odds of a malicious party guessing a matching false instance to match the legitimate indictors. Additionally, by using multiple different triggering conditions, the browser application may further confound a malicious party's attempts to match the display of the legitimate instances 250.

In various embodiments, the output of the security key information may be controlled by user preferences so that a user can select a preferred type of indication that the security key information are provided as (e.g., as audio, as color scheme changes, and graphics, or combinations thereof). Additionally, the user may select that the instances always be provided or are provided on mouse-over or when the window gains focus and for a predefined period of time after losing focus. For example, a user with focus on a first browser window 210 may see the instances 250 update in an associated address bar 230, and on selection of a (purportedly legitimate) second window 260 would expect that the instances 250 in the second address bar 260 would begin to populate with the security key information. The output of the security key information may continue until the user closes the respective windows, or may last for a user-configurable amount of time to ensure that the user has been provided with the security key information, but so as to avoid distracting the user.

FIGS. 3A-3C illustrate a time series for detection of a browser-in-browser attack, according to examples of the present disclosure. In contrast to FIGS. 2A and 2B, which show a legitimate window blocking content of another window, FIGS. 3A-3C illustrate a first browser window 310 displaying a frame 350 that mimics how a second browser window would look and behave if positioned in front of the first browser window 310. As illustrated in FIGS. 3A-3C, a first browser window 310 is displayed with a control ribbon 320 including various controls and an address bar 330 displaying the URL of the currently displayed contents 340 of a webpage, which includes a frame 350 mimicking a second browser window, including a fake address bar 360 and fake contents 370.

At a first time, the first browser window 310 includes a first instance 380 of the security key information in the address bar 330, illustrated as a black star in FIGS. 3A and 3B, and as a first color scheme (e.g., white-text on black-background) in FIG. 3C.

FIG. 3A illustrates a time series for detection of a browser-in-browser attack in which the absence of an instance of the security key information in the frame 350 indicates that the frame 350 is not a legitimate new window compared to the first browser window 310. Although the frame 350 may include elements that look like a legitimate window, complete with a faked URL in the fake address bar 360 and the ability to move the fake window around within the frame 350, the presence of an instance 380 of the security key information in the address bar 330 or first browser window 310 and absences thereof in the fake address bar 360 indicates that the fake address bar 360 does not belong to a legitimate window, and that the contents 340 of the webpage are attempting a browser-in-browser attack. The browser application may display the instance 380 in the address bar 330 to display initial security key information (e.g., a black star) at a first time and updated security key information (e.g., a white pentagon) at a second time.

FIG. 3B illustrates a time series for detection of a browser-in-browser attack in which the malicious party successfully guesses how to represent the security key information (e.g., a black star) at a first time, but guesses innocently how the security key information is output when updated when the browser application updates the security key information at a second time (e.g., as a white pentagon), thereby revealing that the contents 340 of the webpage to be attempting a browser-in-browser attack when the malicious party incorrectly guesses to display a false instance 390 (e.g., a white triangle).

FIG. 3C illustrates a time series for detection of a browser-in-browser attack in which the malicious party successfully guesses how to represent the security key information (e.g., a first color scheme of white-text on a black-background) at a first time, but retains the initial security key information when the browser application updates the security key information at a second time (e.g., as a second color scheme of black-text on a white-background), thereby revealing that the contents 340 of the webpage to be attempting a browser-in-browser attack when the malicious party fails to update the false instance 390 (e.g., remaining in the first color scheme).

Accordingly, the presence of an instance 380 or a difference between an instance 380 and a false instance 390 can be used to identify when what appears to be a legitimate window is actually malicious content attempting to perform a browser-in-browser attack. In contrast to the legitimate windows discussed in relation to FIGS. 2A and 2B, which include shared images or shared color schemes displayed contemporaneously in each of the browser windows to indicate the legitimacy of the browser windows, the mismatching instances in FIGS. 3A-3C indicate that at least one active window (e.g., browser window 310) contains malicious content.

Although not illustrated, output of the security key information includes output of audio signals in some embodiments (e.g., as an accessibility option). The audio signals of matching legitimate browser windows may result in an audio tone increasing in volume as more legitimate browser windows output the same audio signal (e.g., constructively interfering with one another) so that a user can detect the presence of a fake window when the audio signals does not increase in volume or does not output when the fake window is generated compared to when a legitimate new window is opened. Additionally or alternatively, when the malicious party attempts to generate a false audio instance, the false audio instance may clash with the legitimate audio instances (e.g., producing a chord rather than a pure tone, triggering output at the wrong time, conveying incorrect information about the state of the browser application, etc.).

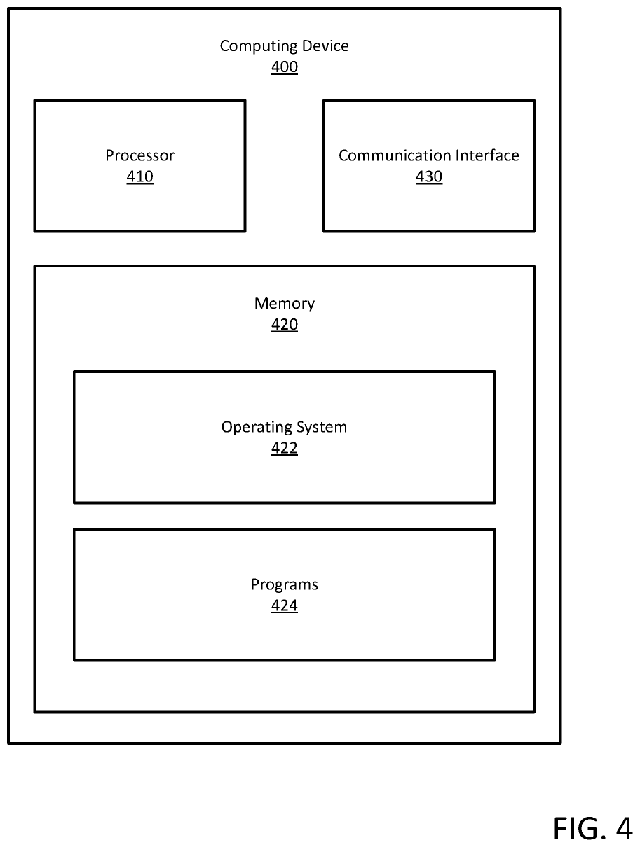

FIG. 4 illustrates physical components of an example computing device 400 according to examples of the present disclosure. The computing device 400 includes at least one processor 410, a memory 420, and a communication interface 430. In various embodiments, the physical components may offer virtualized versions thereof, such as when the computing device 400 is part of a cloud infrastructure providing virtual machines (VMs) to perform some or all of the tasks or operations described for the various devices in the present disclosure.

The processor 410 may be any processing unit capable of performing the operations and procedures described in the present disclosure. In various embodiments, the processor 410 can represent a single processor, multiple processors, a processor with multiple cores, and combinations thereof. Additionally, the processor 410 may include various virtual processors used in a virtualization or cloud environment to handle client tasks.

The memory 420 is an apparatus that may be either volatile or non-volatile memory and may include RAM, flash, cache, disk drives, and other computer readable memory storage devices. Although shown as a single entity, the memory 420 may be divided into different memory storage elements such as RAM and one or more hard disk drives. Additionally, the memory 420 may include various virtual memories used in a virtualization or cloud environment to handle client tasks. As used herein, the memory 420 is an example of a device that includes computer-readable storage media, and is not to be interpreted as transmission media or signals per se.

As shown, the memory 420 includes various instructions that are executable by the processor 410 to provide an operating system 422 to manage various operations of the computing device 400 and one or more programs 424 to provide various features to users of the computing device 400, which include one or more of the features and operations described in the present disclosure. One of ordinary skill in the relevant art will recognize that different approaches can be taken in selecting or designing a program 424 to perform the operations described herein, including choice of programming language, the operating system 422 used by the computing device, and the architecture of the processor 410 and memory 420. Accordingly, the person of ordinary skill in the relevant art will be able to select or design an appropriate program 424 based on the details provided in the present disclosure.

The communication interface 430 facilitates communications between the computing device 400 and other devices, which may also be computing devices 400 as described in relation to FIG. 4. In various embodiments, the communication interface 430 includes antennas for wireless communications and various wired communication ports. The computing device 400 may also include or be in communication, via the communication interface 430, one or more input devices (e.g., a keyboard, mouse, pen, touch input device, etc.) and one or more output devices (e.g., a display, speakers, a printer, etc.).

Accordingly, the computing device 400 is an example of a system that includes a processor 410 and a memory 420 that includes instructions that (when executed by the processor 410) perform various embodiments of the present disclosure. Similarly, the memory 420 is an apparatus that includes instructions that when executed by a processor 410 perform various embodiments of the present disclosure.

Programming modules, may include routines, programs, components, data structures, and other types of structures that may perform particular tasks or that may implement particular abstract data types. Moreover, embodiments may be practiced with other computer system configurations, including hand-held devices, multiprocessor systems, microprocessor-based or programmable user electronics, minicomputers, mainframe computers, and the like. Embodiments may also be practiced in distributed computing environments where tasks are performed by remote processing devices that are linked through a communications network. In a distributed computing environment, programming modules may be located in both local and remote memory storage devices.

It will be appreciated that all of the disclosed methods and procedures described herein can be implemented using one or more computer programs or components. These components may be provided as a series of computer instructions on any conventional computer readable medium or machine readable medium, including volatile or non-volatile memory, such as RAM, ROM, flash memory, magnetic or optical disks, optical memory, or other storage media. The instructions may be provided as software or firmware, and/or may be implemented in whole or in part in hardware components such as ASICs, FPGAs, DSPs or any other similar devices. The instructions may be executed by one or more processors, which when executing the series of computer instructions, performs or facilitates the performance of all or part of the disclosed methods and procedures.

To the extent that any of these aspects are mutually exclusive, it should be understood that such mutual exclusivity shall not limit in any way the combination of such aspects with any other aspect whether or not such aspect is explicitly recited. Any of these aspects may be claimed, without limitation, as a system, method, apparatus, device, medium, etc.

It should be understood that various changes and modifications to the examples described herein will be apparent to those skilled in the relevant art. Such changes and modifications can be made without departing from the spirit and scope of the present subject matter and without diminishing its intended advantages. It is therefore intended that such changes and modifications be covered by the appended claims.

What is claimed is:

1. A method, comprising:
in response to opening a first browser window and a second browser window, retrieving security key information stored by a browser application that are held outside of a document object model accessible by documents through the browser application;
displaying a first instance of the security key information in the first browser window; and
displaying, contemporaneously with display of the first instance of the security key information, a second instance of the security key information in the second browser window.

2. The method of claim 1, wherein the first instance of the security key information is displayed in a first address bar of the first browser window and the second instance of the security key information is displayed in a second address bar of the second browser window.

3. The method of claim 1, wherein the security key information defines a color scheme to display in both the first browser window and the second browser window.

4. The method of claim 1, wherein the security key information defines a shared image to display in both the first browser window and the second browser window.

5. The method of claim 1, wherein the security key information further includes an audio tone that is output as a first audio instance contemporaneously with display of the first instance of the security key information and a second audio instance contemporaneously with display of the second instance of the security key information.

6. The method of claim 1, wherein the browser application updates the security key information at a second time after displaying the first instance of the security key information in the first browser window and the second instance of the security key information in the second browser window by:
retrieving updated security key information stored by the browser application that are held outside of the document object model accessible by the documents through the browser application;
replacing display of the first instance of the security key information in the first browser window with a first instance of the updated security key information; and
replacing, contemporaneously with replacement of the first instance of the security key information, the second instance of the security key information in the second browser window with a second instance of the updated security key information.

7. The method of claim 1, wherein the browser application is triggered to update the security key information in response to a data entry action in the second browser window.

8. A system, comprising:
a processor; and
a memory, including instructions that when executed by the processor perform operations including:
in response to opening a first browser window and a second browser window, retrieving security key information stored by a browser application that are held outside of a document object model accessible by documents through the browser application;
displaying a first instance of the security key information in the first browser window; and
displaying, contemporaneously with display of the first instance of the security key information, a second instance of the security key information in the second browser window.

9. The system of claim 8, wherein the first instance of the security key information is displayed in a first address bar of the first browser window and the second instance of the security key information is displayed in a second address bar of the second browser window.

10. The system of claim 8, wherein the security key information defines a color scheme to display in both the first browser window and the second browser window.

11. The system of claim 8, wherein the security key information defines a shared image to display in both the first browser window and the second browser window.

12. The system of claim 8, wherein the security key information further includes an audio tone that is output as a first audio instance contemporaneously with display of the first instance of the security key information and a second audio instance contemporaneously with display of the second instance of the security key information.

13. The system of claim 8, wherein the browser application updates the security key information at a second time after displaying the first instance of the security key information in the first browser window and the second instance of the security key information in the second browser window by:
retrieving updated security key information stored by the browser application that are held outside of the document object model accessible by the documents through the browser application;
replacing display of the first instance of the security key information in the first browser window with a first instance of the updated security key information; and
replacing, contemporaneously with replacement of the first instance of the security key information, the second instance of the security key information in the second browser window with a second instance of the updated security key information.

14. The system of claim 8, wherein the browser application is triggered to update the security key information in response to a data entry action in the second browser window.

15. A memory, including instructions that when executed by a processor perform operations including:
in response to opening a first browser window and a second browser window, retrieving security key information stored by a browser application that are held outside of a document object model accessible by documents through the browser application;
displaying a first instance of the security key information in the first browser window; and
displaying, contemporaneously with display of the first instance of the security key information, a second instance of the security key information in the second browser window.

16. The memory of claim 15, wherein the first instance of the security key information is displayed in a first address bar of the first browser window and the second instance of the security key information is displayed in a second address bar of the second browser window.

17. The memory of claim 15, wherein the security key information defines a color scheme to display in both the first browser window and the second browser window.

18. The memory of claim 15, wherein the security key information defines a shared image to display in both the first browser window and the second browser window.

19. The memory of claim 15, wherein the security key information further includes an audio tone that is output as a first audio instance contemporaneously with display of the first instance of the security key information and a second audio instance contemporaneously with display of the second instance of the security key information.

20. The memory of claim 15, wherein the browser application updates the security key information at a second time after displaying the first instance of the security key information in the first browser window and the second instance of the security key information in the second browser window by:
retrieving updated security key information stored by the browser application that are held outside of the document object model accessible by the documents through the browser application;
replacing display of the first instance of the security key information in the first browser window with a first instance of the updated security key information; and
replacing, contemporaneously with replacement of the first instance of the security key information, the second instance of the security key information in the second browser window with a second instance of the updated security key information.
